(19) United States
(12) Patent Application Publication
(10) Pub. No.: US 2015/0158237 A1
(43) Pub. Date: Jun. 11, 2015

(54) VACUUM FORMING PROCESS AND USE

(71) Applicant: EVONIK INDUSTRIES AG, Essen (DE)

(72) Inventors: Torsten Frank, Gernsheim (DE); Manfred Rimpl, Otzberg (DE); Vitali Klein, Gross-Zimmern (DE)

(73) Assignee: EVONIK INDUSTRIES AG, Essen (DE)

(21) Appl. No.: 14/412,477

(22) PCT Filed: Jun. 20, 2013
(86) PCT No.: PCT/EP2013/062874

§ 371 Date: Jan. 2, 2015

(30) Foreign Application Priority Data
Jul. 4, 2012 (DE) 10 2012 211 636.2

(51) Int. Cl. B29C 51/10; C08L 27/16; C08L 33/12; C08L 69/00; C08F 120/14; C08G 64/00

(52) U.S. Cl. CPC B29C 51/10; C08F 120/14; C08G 64/00; C08L 33/12; C08L 69/00; C08L 27/16; B29K 2033/12

(57) ABSTRACT

A vacuum thermoforming process for producing a transparent molding free from optical defects, whereby the prior temperature of the mold and preform is controlled, the preform is premolded, the mold is shaped under sub-atmospheric pressure, the mold shape is cooled, and the transparent molding is removed. The transparent plastic molding is produced from polymethyl methacrylate (PMMA) or polycarbonate (PC) with particularly good optical quality and with relatively low cycle times. Upon removal, these moldings are dimensionally stable, free from distortion, and exhibit no surface defects such as pimples.

### FIELD OF THE INVENTION

The invention describes an essential mould for a process which produces, from a semi-finished PMMA product, a panel free from optical defects. This present invention in particular relates to a novel vacuum thermoforming process which can produce, from PMMA or PC, transparent plastics mouldings with particularly good optical quality, with economic cycle times. On removal from this process, these mouldings are dimensionally stable and free from distortion. The transparent mouldings moreover exhibit no surface defects such as pimples. There is moreover no need for any additional substances such as lubricant or material which would have to be applied to the mould in a process of the prior art.

### PRIOR ART

Automobile manufacturers and suppliers regard lightweight construction as the key technology for reducing consumption of fossil fuels or for extending the range of electrically driven vehicles, thus increasing their acceptability. Another increasingly important factor here is the replacement of glass by plastics. Weight savings possible here are from 40 to 50%. Approvals have been issued not only for polycarbonate but also for glazing made of polymethyl methacrylates. Glazing made of plastics not only reduces weight but also increases design freedom. A problem hitherto with production of glazing by the thermoforming process has been the impossibility of thermoforming glazing without pimples. The said “pimples” mostly involve circular defects on the surface of the glazing after removal from the thermoforming mould.

There are already a number of well-established processes for producing transparent mouldings made of polycarbonate (PC) or polymethyl methacrylate (PMMA), of the type that can be used by way of example as glazing in automobile construction. However, these have generally been optimized for PC and have major disadvantages for the processing of PMMA, in particular when the number of units produced is relatively large.

Large numbers of units of PC mouldings can, by way of example, be produced by means of injection-compression moulding processes. This type of injection-compression moulding process can by way of example produce transparent vehicle roofs with an area of about 1.5 m² in a cycle that takes from 4 to 5 minutes. However, with PC the scrap rate is relatively high. It is impossible to process PMMA because the product has high levels of haze. The investment required for this type of plant is relatively high, and annual output rates below 10 000 units/year are therefore uneconomic.

On the other hand, small numbers of units can be produced, either from PC or from PMMA, by means of drape forming or overlay forming. Here, a mould is covered with a material and then a cut-to-size plastic, e.g. made of PMMA, is placed thereon. After heating in an oven in the temperature range from 115° to 140° C., the cut-to-size material replicates the shape of the mould, and can be removed after—inclusive of cooling time—about 4 h. Limiting factors are the size of the oven and also therefore the distribution of heat within the oven.

Overall, the said process is very non-aggressive and achieves excellent optical quality results. However, because this process is very time-consuming it is suitable only for output rates of at most 1000 units/year.

The vacuum thermoforming process represents an alternative method for producing plastics mouldings. Advantages of this process are moderate to short cycle times and a low product scrap rate. This process has been used hitherto by way of example to manufacture PMMA illuminated signs for the advertising industry or polystyrene (PS) refrigerator cladding. The optical quality achieved is good but still not adequate for an automobile application, in particular as glazing: curved, transparent plastics mouldings produced by means of vacuum thermoforming always exhibit high levels of stress within the polymer matrix. These stresses in turn cause high levels of distortion when objects are viewed through the products, and these panels are therefore unsuitable for glazing. These plastics mouldings, in particular those made of PMMA or PC, also often have surface defects, known as pimples.

### Object

In the light of the prior art discussed, it was therefore an object of the present invention to provide a novel production process for producing transparent plastics mouldings with good optical quality without use of forming aids such as lubricants or coverings of material on the mould.

A particular intention is that the said process be capable of operation with short cycle times and with a low scrap rate or low production defects.

Another intention is that the process be economic for average output rates of from 1000 to 100 000 units/year.

A very particular object of the present invention was to provide a process which can produce transparent plastics mouldings without pimples or other defects on the surface, and at the same time without optically relevant stresses in the polymer matrix.

### Achievement of Object

The objects were achieved by providing a novel vacuum thermoforming process. The said novel process can for the first time produce transparent mouldings such as those that can be used by way of example for automobile glazing with economic cycle times. The said process is composed of the following steps:
a) prior temperature control of the mould and of a preform made of a transparent plastic,
b) premoulding of the said preform, preferably by means of compressed air or under sub-atmospheric pressure, e.g. in a vacuum,
c) shaping within the mould, at a mould temperature which is above the Vicat softening point of the transparent plastic, under sub-atmospheric pressure, e.g. in a vacuum,
d) cooling of the shaping mould, and also of the component, and
e) removal of the transparent moulding.

The prior temperature control in step a) can preferably be achieved by means of induction by a Variotherm mould, by means of IR radiation or by an electrical cartridge heater.

In general terms the fact that transparent mouldings of this type can be produced with high optical quality by means of a vacuum thermoforming process is in itself already surprising.

Mouldings produced by means of a vacuum thermoforming process according to the prior art exhibited relatively high levels of stress in the polymer matrix, which in turn led to relatively high levels of distortion for an observer of an image viewed through the panel. Surprisingly, having found that the process according to the invention can avoid these stresses, it is therefore possible to produce curved panels of high optical quality with a high level of freedom from distortion.

Surprisingly, it was also found that the optical quality of the surface in respect of reduced pimpling increases significantly if the temperature of the mould used is controlled in step c) to a temperature above the Vicat softening point.

Another achievement of the present invention is that by virtue of the additional step d) the finished mouldings are dimensionally stable and therefore can be removed in transportable form from the mould. It must therefore be possible to carry out steps c) and d) in the same mould section. Cooling is achieved here after conclusion of shaping in the, still closed, mould section that was used to carry out step c).

Another advantage of the invention is that, independently of the size of the component, it is possible to achieve cycle times of less than 10 min, in particular less than 6 min and, given further optimization, less than 4 min.

Another surprising advantage obtained from the present invention is that the process can be carried out without use of forming aids, such as lubricants or coverings of material on the mould surface. This in turn contributes to an additional increase in surface quality.

In one particular embodiment, the process according to the invention is carried out with the aid of a single-station vacuum thermoforming machine. When moulds that can be used for the vacuum thermoforming process are considered, a distinction is generally made between single-station and multi-station machines. In the case of a single-station machine, or in more precise terms a single-station vacuum thermoforming machine, steps a) to d) take place in the same mould. On the other hand, in a multi-station machine, or multi-station vacuum thermoforming machine, steps a), b) and c) can respectively take place in separate mould sections. The general procedure of at least step a) is spatially separate from the other steps, while steps b) to d) or at least c) and d) take place in the same mould section. The process according to the invention can in principle be implemented in any of the machines mentioned.

Either single-station tooling or multi-station tooling can moreover have other attached tooling components, for example a punch and a stacker. Information concerning various elements of vacuum thermoforming machines of this type which are suitable in principle for a vacuum thermoforming process can be found in Becker, Braun, Kunststoff-Handbuch Polyvinylchlorid 2/2 [Plastics Handbook, Polyvinyl chloride 2/2], Hanser Verlag, Munich, 2nd edition, 1986, ISBN 3-446-14161-8, pp. 1133-44.

The transparent plastic preferably involves a polymethyl methacrylate (PMMA) or involves a polycarbonate (PC). Equally preferably, a mixture of PMMA and PC can be involved, or a mixture of PMMA or PC with one or more other constituents can be involved. The said other constituents can in particular involve polyvinylidene fluoride (PVDF).

The PMMA can involve pure PMMA or can involve a copolymer of MMA and up to 20% by weight of other comonomers, such as in particular alkyl esters of acrylic acid, as matrix material. It is also possible that the PMMA, together with the matrix material, comprises up to 80% by weight of impact modifier, preferably (meth)acrylate-based core-shell or core-shell-shell particles. The expression (meth)acrylate here comprises methacrylates, acrylates and in particular mixtures of acrylates and methacrylates.

The preforms and the mouldings produced therefrom according to the invention can comprise other added substances, such as processing aids, stabilizers, or additives, alongside the polymeric constituents: by way of example, UV absorbers and/or IR absorbers or UV stabilizers can be present. Dyes can also be present, but these are not permitted to cause haze. Additives for improving scratch resistance may also have been added. The processing aids can by way of example involve rheology modifiers, flow aids or dispersing agents.

In another embodiment of the invention, the preform involves a multilayer preform made of transparent plastics. At least one of the layers here is composed of PMMA or of PC. The other layers can equally be composed of PMMA or PC or of another plastic, for example of PVDF.

The moulding can moreover also be coated after and/or before removal in step e). Coating before removal means that the coating takes place in the mould before or during step b) or preferably during step c). There are a number of possible variants here. Firstly, the material for the coating can be conducted into or injected into the mould after introduction of the preform. Secondly, the material for the coating can be placed in the form of a type of foil in advance in the mould, or can be placed previously onto the preform. In another possibility, the surface of the inner side of the mould can have been provided in advance with the coating. The preform can also be coated before introduction into the mould. However, this last variant is less preferred because this procedure can result in non-uniform coating—because of the shaping process.

Preference is given to a process in which, during step c), the moulding is provided with a coating, and in which the said coating is previously placed on the mould surface.

The coatings can involve various coatings well known to the person skilled in the art. The examples below do not therefore restrict the invention in any way: the coating can involve a transparent coloured layer in order by way of example to realize tinted glazing. The coating can also comprise UV absorbers and/or IR absorbers, in order by way of example, in the case of automobile glazing, to reduce heating of the vehicle interior. The coating can also involve a scratch-resistant coating and/or an anti-soiling coating. Preference is given in particular to coatings which perform two or more of the functions mentioned.

After conclusion of the process, the moulding can be subjected to further treatment: in one possibility by way of example the moulding is polished and/or cut to size at the edges after removal. In another possibility, the completed moulding is provided on one or both sides, entirely or to some extent, with a protective foil. Damage during storage or during transport is thus avoided.

Preference is given to a process in which a plurality of mouldings are produced in a cycle: in one particular embodiment of the invention which can also achieve shorter cycle times, a plurality of product parts can be cut from a moulding after removal. The yield of mouldings can thus be multiplied with the use of only one mould.

The present invention provides not only the process but also the use of a transparent moulding produced by means of the claimed process. These claimed uses can in particular involve a use as automobile glazing, window in a building, or lamp covering, or in general terms as decorative element.

### EXAMPLES

There follows an example of a specification for using vacuum thermoforming to produce printed automobile glazing free from optical defects:

The semi-finished product previously printed (e.g. with Noricryl from Proell) is placed in a vacuum thermoforming machine (e.g. a T9 from Geiss). Radiant heaters heat the substrate. Radiant heaters made of quartz glass can be used for this purpose, or else Speedium radiant heaters. During the heating procedure, the clamping frame remains very slightly open, and it finally closes when the temperature of the substrate has reached about 115° C.

Once the heating of the cut-to-size section placed in the machine has been concluded, the pre-stretching procedure can then be begun. Super- or sub-atmospheric pressure is used for this. A decisive factor here is that the resultant bubble already approximately replicates the shape of the mould.

Once the pre-stretching procedure has been concluded, the mould moves into the bubble. It is important that the temperature of the mould has been controlled to the temperature range from 110° C. to 140° C., so that high surface quality (Class A surface) can also subsequently be ensured on the plastic/PMMA contact side.

Vacuum is then applied so as to bring the heated substrate into close contact with the heated mould, and replicate the mould.

After a certain holding time, the machine begins to use blowers to cool the substrate from above, and at the same time the mould is also adjusted to a temperature markedly below the Vicat point, and the mould thus assists the cooling process.

Once the temperature of the substrate is below the long-term service temperature, the procedure for removal from the mould can be begun. Without the cooling due to the mould, the high temperature of the mould causes heating of the moulding, which loses its dimensional accuracy for removal from the mould. Once the vacuum has been switched off, the mould returns to base position. Once this has occurred, the clamping frame also returns to base position, and the finished moulding can therefore be removed.

1. A vacuum thermoforming process for producing a transparent molding, comprising:
a) controlling the temperature of a mold and of a preform comprising a transparent plastic,
b) premolding the preform to produce a premold,
c) shaping the premold within the mold, under sub-atmospheric pressure and at a mold temperature which is above a Vicat softening point of the transparent plastic, to produce a component,
d) cooling the mold, and also of the component in the mold to produce the transparent molding, and
e) removing the transparent molding from the mold.

2. The process according to claim 1, wherein compressed air is employed for the premolding in b).

3. The process according to claim 1, wherein a vacuum is employed for the premolding in b) and/or for the shaping in c).

4. The process according to claim 1, wherein controlling the temperature in a) is achieved by induction by a Variotherm mold, IR radiation or an electrical cartridge heater.

5. The process according to claim 1, wherein the transparent plastic comprises at least one selected from the group consisting of polymethyl methacrylate (PMMA) and polycarbonate (PC).

6. The process according to claim 1, wherein the preform is a multilayer preform comprising a transparent plastic, wherein a layer of the multilayer preform comprises PMMA or PC.

7. The process according to claim 1, further comprising coating the molding after and/or before the removing.

8. The process according to claim 1, wherein, during the shaping in c), the molding is provided with a coating, and the coating is previously placed on the mold surface.

9. The process according to claim 1, wherein the molding is polished and/or cut to size at the edges after removal.

10. The process according to claim 1, wherein a plurality of product parts are cut from the molding after removal.

11. The process according to claim 1, wherein a plurality of moldings are produced in a cycle.

12. The process according to claim 1, wherein the preform is provided with a protective foil on one or both sides, entirely or to some extent.

13. The process according to claim 1, wherein the process is carried out with the aid of a single-station vacuum thermoforming machine.

14. An automobile glazing, a window in a building, a lamp covering, or a decorative element, which has been produced with the transparent molding produced according to claim 1.
